(19) United States
(12) Patent Application Publication
(10) Pub. No.: US 2017/0227817 A1
(43) Pub. Date: Aug. 10, 2017

(54) BACKLIGHT UNIT, BACKLIGHT MODULE, BACKLIGHT MODULE AND DISPLAY DEVICE

(71) Applicant: Shenzhen china Star Optoelectronics Technology Co. Ltd., Shenzhen, Guangdong (CN)

(72) Inventor: Yong FAN, Shenzhen, Guangdong (CN)

(73) Assignee: Shenzhen China Star Optoelectronics Technology Co. Ltd., Shenzhen, Guangdong (CN)

(21) Appl. No.: 14/905,263

(22) PCT Filed: Dec. 22, 2015
(86) PCT No.: PCT/CN2015/098336

§ 371 Date: Jan. 14, 2016

(30) Foreign Application Priority Data
Oct. 29, 2015 (CN) 201510724162.4

(51) Int. Cl. G02F 1/1335

(52) U.S. Cl. CPC G02F 1/133605; G02F 1/133606; G02F 1/133608; G02F 1/133603; G02F 1/133524; G02F 2001/133628

(57) ABSTRACT

A backlight unit comprises a main reflection sheet, a light guide plate arranged on reflection surface of the main reflection sheet, a light source and a deputy reflection sheet. A groove located at middle of the light output surface of the light guide plate. The deputy reflection sheet is arranged on the light output surface and covers the groove, and the reflection surface of the deputy reflection sheet is toward the light source of the backlight module. The units are arranged on bottom surface of the receiving groove at intervals, and a diffusion plate seals the receiving groove and is disposed opposite to the light output surface.

### CROSS REFERENCE

This application claims the priority of Chinese Patent Application No. 201510724162.4, entitled “Backlight unit, backlight module, backlight module and display device”, filed on Oct. 29, 2015, the disclosure of which is incorporated herein by reference in its entirety.

### FIELD OF THE INVENTION

The present invention relates to an LCD technology field, and more particularly to a backlight unit, a backlight module, a backlight module and a display device.

### BACKGROUND OF THE INVENTION

LCD is the mainstream display device technology on the market today. The display device needs a backlight as a light source to switch the LCD. Conventional backlight module is divided into direct backlight and edge backlight. Edge backlight needs a light guide plate, the light guide plate is bigger the cost is higher. Direct backlight is thicker, in order to reduce the thickness of the light box, mainly taken to increase the number of lights or increase the LED lens to expand the light distribution to achieve, take these two methods, the bigger size it is, the higher cost it would be. Therefore, with increasingly fierce competition in the large-sized display device, increase the scale of the large-sized and decrease the cost become the main indicators to enhance the competitiveness of products. How to achieve the thinness of the large-sized direct backlight and decrease the cost of the direct backlight become an important direction of technology development.

### SUMMARY OF THE INVENTION

The present invention provides a backlight unit and a backlight module to achieve the purposes of thinner backlight module to saving the cost.

The present invention also provides a display device.

The present invention provides a backlight unit comprises a main reflection sheet, a light guide plate arranged on reflecting surface of the main reflection sheet, a light source and a deputy reflection sheet; the light guide plate comprises a light output surface and a groove located at middle of the light output surface. The light source is arranged in the groove. The deputy reflection sheet is arranged on the light output surface and covers the groove, the reflection surface of the deputy reflection sheet is toward the light source.

The backlight module comprises a backplane, a plurality of backlight units and a diffusion plate, the backplane forming a receiving groove, the backlight unit comprises a main reflection sheet, a light guide plate arranged on reflection surface of the main reflection sheet, a light source and a deputy reflection sheet; the light guide plate comprises a light output surface and a groove located at middle of the light output surface. The light source is arranged in the groove. The deputy reflection sheet is arranged on the light output surface and covers the groove, the reflection surface of the deputy reflection sheet is toward the light source; the several backlight units are arranged on a bottom surface of the receiving groove at intervals, the diffusion plate sealing the receiving groove and disposed opposite to the light output surface.

Where, the several backlight units are arranged in a matrix and arranged a support body between each two of the backlight units. The opposite ends of the support body supports respectively the bottom surface and the diffusion plate.

Where, the backlight unit further comprises a heat sink, which the heat sink is arranged on the surface of the main reflection sheet toward the bottom surface and is disposed opposite to the light source.

Where, the reflectance of the deputy reflection sheet is greater than the reflectance of the main reflection sheet.

Where, the groove extending through the light guide plate, the light source in the groove is arranged on the main reflection sheet.

Where, the backplane comprises a base plate and a side plate provided on the periphery of the base plate, the side plate and the base plate enclosing the receiving groove, the surface of the base plate in the receiving groove is the bottom surface.

Where, the side plate includes a connecting section and a hypotenuse extending the connecting section, the connecting section connects with the base plate, the hypotenuse connects with the connecting section and the diffusion plate, and a side reflection sheet is disposed toward surface of the connecting section and the hypotenuse.

Where, the backlight module further comprising an optical film, the optical film is provided on the light output surface of the diffusion plate.

Where, the light source is LED lights packaged by CSP.

The present invention also provides a display device comprising the backlight module and a liquid crystal panel. The liquid crystal panel is arranged on the backlight module and is disposed opposite to the light output surface of the light guide plate.

The backlight module of the present invention is provided light by a plurality of independent backlight unit. Each backlight unit uses a separate light guide plate for a single light source, and the light guide plate material can be sufficiently utilized, to ensure the distribution of light, without adding the lens to expand light., The thickness dimension of the backboard is saved. Compared with the overall light guide plate, the cost is saved.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structure diagram of preferred embodiment according to the backlight unit of the backlight module of the present invention;

FIG. 2 is a section diagram of backlight module overall structure of the present invention.

FIG. 3 is a section diagram of display device having a backlight module of the present invention.

### DETAILED DESCRIPTION OF PREFERRED EMBODIMENTS

The present invention will now be combined with the implementation of the drawings, were a clear example of the technical solutions of the present invention, a complete description of.

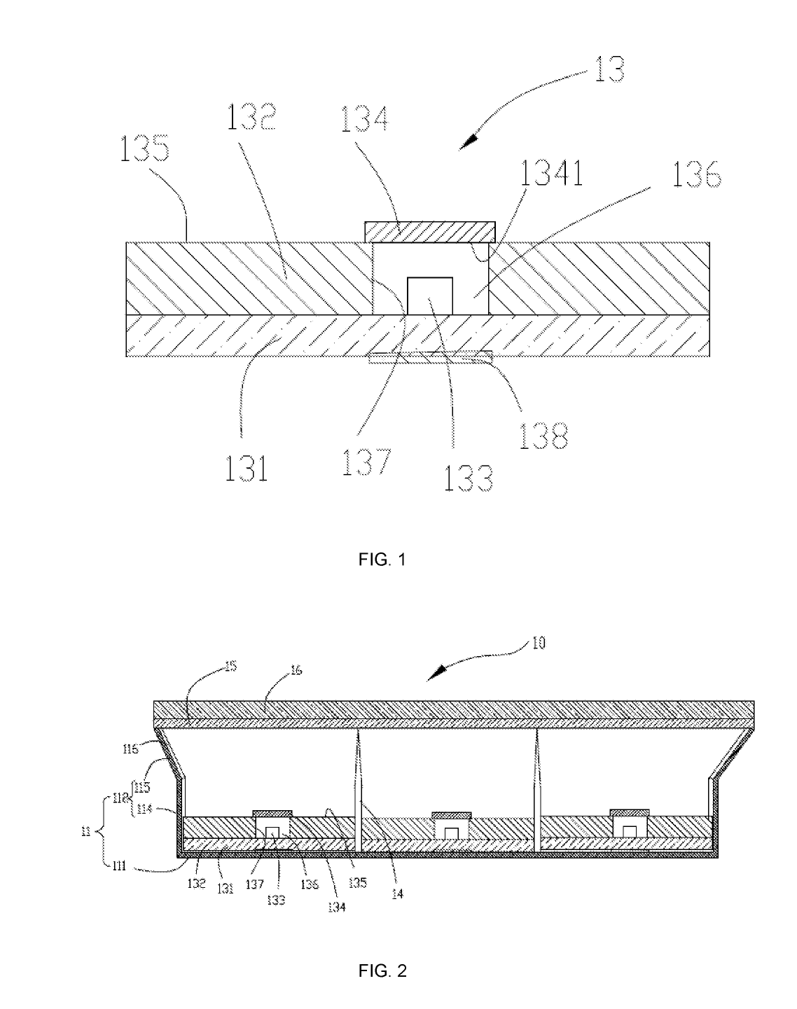

Please refer to FIGS. 1 and 2, a backlight unit and backlight module 10 in the present invention, the backlight unit is the light source of the backlight module, the backlight module providing light source for the display device. The backlight module 10 is a direct backlight, which comprises a backplane 11, several backlight units 13 and a diffusion plate 15. The backplane 11 has a receiving groove 12. The backlight unit 13 comprises a main reflection sheet 131, a light guide plate 132 arranged on the reflection surface of the main reflection sheet 131, a light source 133 and a deputy reflection sheet 134. The light guide plate 132 comprises a light output surface 135 and a groove 136 at the middle of the light output surface. The light source 133 is arranged in the groove 136. The deputy reflection sheet 134 is arranged on the light output surface 135 and covers the groove 136. The reflection surface of the deputy reflection sheet 134 is toward the light source 133. The several backlight units 13 are arranged on the bottom surface 121 of the receiving groove 12 at intervals, and the diffusion plate 15 blocked the receiving groove 12 and oppositely disposed to the light output surface 135.

The backlight module 10 i has a plurality of independent backlight units to provide light, and each backlight unit uses a separating light guide plate 132 for a single light source 133. The light guide plate material can be sufficiently utilized to ensure the distribution of light, without adding the lens to expand light, for saving the thickness dimension of the backboard and the overall space. For the large-sized backlight module, compared to the cost of using the overall light guide is more cost-effective. At same time, the light source 133 is LED lights packaged by CSP, which the power is higher, and has surface light emitting. The number of light source was not increased in the backlight unit 13 which can decrease the cost of light source; the overall can ensure adequate light source efficiency without increasing the thickness space of backboard.

In this embodiment, the backplane 11 comprises a base plate 111 and a side plate 112 provided on the periphery of the base plate 111. The side plate 112 and the base plate 111 enclosing the receiving groove 12, the surface of the base plate 111 in receiving groove 12 is the bottom 121. Further, the side plate 112 comprises a connecting section 114 and a hypotenuse 115 extending the connecting section 114. The connecting section 114 connects with the base plate 111, and the hypotenuse 115 connects with the connecting section 114 and the diffusion plate 15. And the connecting section 114 and the hypotenuse 115 is toward the surface of the receiving groove 12 providing a side reflection sheet 116. The side reflection sheet 116 can avoid the bright band or the dark frame for the side position of backplane 11.

In this embodiment, the receiving groove 12 is substantially rectangular, and the peripheral of the diffusion plate 15 supports the side plate 112 and block the receiving groove 12, the diffusion plate 15 is used to break up the flux, so that the light can uniform light distribution and also control the light emission angle. The surface of the diffusion plate 15 light output direction also is superimposed with an optical film 16. The optical film 16 is used to diffuse the incident light from the sources uniformly to turn the light into the diffusive light source, so that the light is very uniform. It can solve the spot problem of the backlight module.

Further, the several backlight units 13 are arranged in a matrix and arranged a support body 14 between each two of the backlight units 13. The opposite ends of the support body 14 support respectively the bottom surface 121 and the diffusion plate 15. The support body 14 supporting the diffusion plate 15 to keep the backlight unit 13 and the diffusion plate 15 have some light mixing distance, to keep the diffusion plate 15 away from collapsing.

In this embodiment, the main reflection sheet 131 is arranged on the bottom surface 121 of the receiving groove 12. The reflection surface of the main reflection sheet 131 is toward the light source 133. The deputy reflection sheet 134 is arranged on the light output surface 135 of the light guide plate 132. The reflection surface 1341 of the deputy reflection sheet 134 is toward the light source 133. The groove 136 extends through the light guide plate 132, and the light source 133 in the groove is arranged on the main reflection sheet 131, where the groove 136 of two opposite side walls 137, the main reflection sheet 131 and the deputy reflection sheet 134 encloses a space, and the light source 133 is arranged in the space where the reflectance of the deputy reflection sheet 134 is greater than the reflectance of the main reflection sheet 141.

When the backlight module light source 133 is lighting, part of the light of the light source 133 through the two opposite side walls 137 of the groove 136 goes into the light guide plate 132, and emits through the light output surface 135 of the light guide plate 132. After the diffusion plate 15 and optical film 16 operates light finally, the light is emitted from the backlight module After part of the light source 133 is reflected through the main reflection sheet 131 and the deputy reflection sheet 134, the light further goes into the light guide plate 132, Then, the light is emitted by the light output surface 135 of the light guide plate 132 to fully use all of the light from the light source 133.

Further, the backlight unit 13 further comprises a heat sink 138, which the heat sink 138 is arranged on the surface of the main reflection sheet 131 toward the bottom surface 121 and is disposed opposite to the light source 133. The present invention can achieve cooling the light source 133.

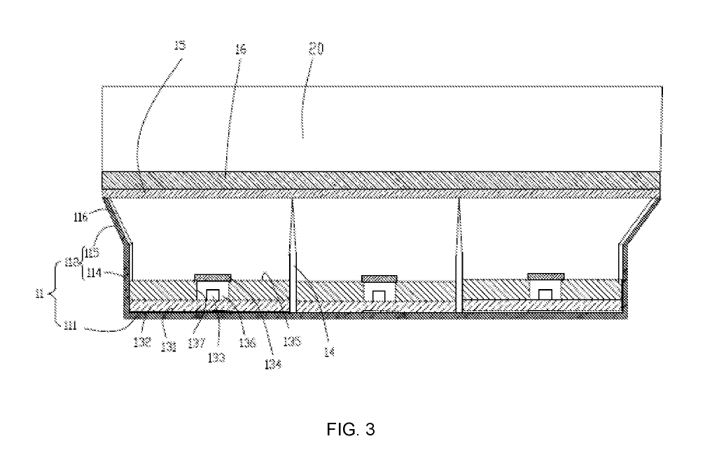

Please refer to FIG. 3, the present invention further provide a display device which comprises the backlight module 10 and a liquid crystal panel 20. The liquid crystal panel 20 is arranged on the backlight module 10 and is disposed opposite to the light output surface of the light guide plate 132. The light through the optical film 16 is provided for the liquid crystal panel 20 to achieve the screen display.

The above is a preferred embodiment of the present invention, it should be noted that those of ordinary skill in the art, in the present invention without departing from the principles of the premise, but also many improvements and modifications may be made, such modifications and retouching is also considered the scope of the invention.

What is claimed is:

1. A backlight unit characterized by comprising a main reflection sheet, a light guide plate arranged on a reflection surface of the main reflection sheet, a light source and a deputy reflection sheet; the light guide plate comprising a light output surface and a groove located at middle of the light output surface, the light source setting in the groove, the deputy reflection sheet arranged on the light output surface and covering the groove, a reflection surface of the deputy reflection sheet being toward the light source.

2. A backlight module characterized by comprising a backplane, a plurality of backlight units and a diffusion plate, the backplane forming a receiving groove, the backlight unit comprising a main reflection sheet, a light guide plate arranged on a reflection surface of the main reflection sheet, a light source and a deputy reflection sheet; the light guide plate comprising a light output surface and a groove located at middle of the light output surface, the light source arranged in the groove, the deputy reflection sheet arranged on light output surface and covering the groove, a reflection surface of the deputy reflection sheet facing toward the light source; the backlight units arranged on a bottom surface of the receiving groove at intervals, the diffusion plate blocked the receiving groove and disposed opposite to the light output surface.

3. The backlight module according to claim 2, wherein the plurality of backlight units are arranged in a matrix and a support body are arranged between each two of the backlight units, the bottom surface and the diffusion plate are supported respectively by two opposite ends of the support body.

4. The backlight module according to claim 2, wherein the backlight unit further comprising a heat sink and the heat sink is arranged on the main reflection sheet faces toward a surface of the bottom surface and is opposite to the light source.

5. The backlight module according to claim 2, wherein reflectance of the deputy reflection sheet is greater than reflectance of the main reflection sheet.

6. The backlight module according to claim 2, wherein the backplane comprises a base plate and a side plate provided on periphery of the base plate, and the side plate and the base plate enclose the receiving groove, surface of the receiving groove in the base plate is the bottom surface.

7. The backlight module according to claim 6, wherein the side plate includes a connecting section and a hypotenuse extending the connecting section, the connecting section connects with the base plate, the hypotenuse connects with the connecting section and the diffusion plate, and a side reflection sheet is disposed toward surface of the connecting section and the hypotenuse.

8. The backlight module according to claim 2, wherein the backlight module further comprises an optical film, the optical film is provided on light output surface of the diffusion plate.

9. The backlight module according to claim 2, wherein the light source is LED lights packaged by CSP.

10. A display device comprising a backlight module and a liquid crystal panel, the liquid crystal panel arranged on the backlight module and disposed opposite to the light output surface of the light guide plate; wherein the backlight module comprises a backplane, a plurality of backlight units and a diffusion plate, the backplane form a receiving groove, the backlight unit comprising a main reflection sheet, a light guide plate arranged on reflection surface of the main reflection sheet, a light source and a deputy reflection sheet; the light guide plate comprising a light output surface and a groove located at middle of the light output surface, the light source arranged in the groove, the deputy reflection sheet arranged on the light output surface and covering the groove, reflection surface of the deputy reflection sheet faces toward the light source; the plurality of backlight units are arranged on bottom surface of the receiving groove at intervals, the diffusion plate sealing the receiving groove and disposed opposite to the light output surface.

11. The display device according to claim 10, wherein e plurality of backlight units are arranged in a matrix and a support body are arranged between each two of the backlight units, the bottom surface and the diffusion plate are supported respectively by two opposite ends of the support body.

12. The display device according to claim 10, wherein the backlight unit further comprising a heat sink, and the heat sink is arranged on the main reflection sheet faces toward a surface of the bottom surface and is opposite to the light source.

13. The display device according to claim 11, wherein reflectance of the deputy reflection sheet is greater than reflectance of the main reflection sheet

14. The display device according to claim 11, wherein the backplane comprises a base plate and a side plate provided on periphery of the base plate, and the side plate and the base plate enclose the receiving groove, surface of the receiving groove in the base plate is the bottom surface.

15. The display device according to claim 14, wherein the side plate includes a connecting section and a hypotenuse extending the connecting section, the connecting section connects with the base plate, the hypotenuse connects with the connecting section and the diffusion plate, and a side reflection sheet is disposed toward surface of the connecting section and the hypotenuse.

16. The display device according to claim 11, wherein the backlight module further comprises an optical film, the optical film is provided on light output surface of the diffusion plate.

17. The display device according to claim 11, wherein the light source is LED lights packaged by CSP.
